(19) United States
(12) Patent Application Publication
(10) Pub. No.: US 2008/0195729 A1
(43) Pub. Date: Aug. 14, 2008

(54) PATH IDENTIFICATION FOR NETWORK DATA

(75) Inventors: Jagdish Chand, Fremont, CA (US); Suresh Antony, San Jose, CA (US); Rajesh Bhargava, Fremont, CA (US); Avanti Nadgir, Sunnyvale, CA (US); Jagannatha Narayanareddy, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/673,857

(22) Filed: Feb. 12, 2007

(51) Int. Cl. G06F 15/173

(52) U.S. Cl. 709/224

(57) ABSTRACT

A solution is provided wherein a master process and two or more drone processes may be utilized to identify path information containing a pattern. The master process may send the pattern to the two or more drone processes, which may identify the pattern in path data. Each drone process may then send the paths that satisfy the pattern back to the master process, which may aggregate the path data so that two or more identical paths appearing in the path data are reduced to a single occurrence of a path.

### RELATED APPLICATION

This application is related to U.S. patent application Ser. No. ______, entitled “PATH INDEXING FOR NETWORK DATA” (Attorney Docket No. YAH1P055), filed concurrently herewith by Jagdish Chand, Suresh Antony, Rajesh Bhargava, Avanti Nadgir, and Jagannatha Narayanareddy.

### BACKGROUND OF THE INVENTION

1. Field of the Invention

The present invention relates to network usage data. More particularly, the present invention relates to path identification for network data.

2. Description of the Related Art

The process of analyzing Internet-based actions such as web surfing patterns is known as web analytics. One part of web analytics is understanding how user traffic flows through a network (also known as user paths). This typically involves analyzing which nodes a user encounters when accessing a particular network. In large networks such as, for example, large search engine/directories, billions of pageviews may be generated per day. As such, analyzing this huge amount of data can be daunting. Such analysis is needed, however, to determine common user behavior in order to optimize the network for better user engagement and network integration.

Due to the plentiful nature of this network data, however, performing analysis can be time-consuming. Even the identification of useful patterns can take hours or days, amounts of time that are unacceptable to most of the people interested in finding the patterns (e.g., managers, CEOs, etc.). As such, what is needed is a faster way to identify useful patterns in such a large data set.

### SUMMARY OF THE INVENTION

A solution is provided wherein a master process and two or more drone processes may be utilized to identify path information containing a pattern. The master process may send the pattern to the two or more drone processes, which may identify the pattern in path data. Each drone process may then send the paths that satisfy the pattern back to the master process, which may aggregate the path data so that two or more identical paths appearing in the path data are reduced to a single occurrence of a path.

### BRIEF DESCRIPTION OF THE DRAWINGS

FIG. 1 is a diagram illustrating the structure of the files in accordance with an embodiment of the present invention.

FIG. 2 is a diagram illustrating an architecture of an indexing engine in accordance with an embodiment of the present invention.

FIG. 3 is a diagram illustrating a path file, node path index file, and node index file for the first bucket in the above example.

FIG. 4 is a diagram illustrating an architecture for the efficient identification of patterns in path data in accordance with an embodiment of the present invention.

FIG. 5 is a diagram illustrating an example of how patterns are extracted using a drone in accordance with an embodiment of the present invention.

FIG. 6 is a flow diagram illustrating a method for identifying path information containing a pattern in accordance with an embodiment of the present invention.

FIG. 7 is a flow diagram illustrating a method for identifying path information containing a pattern in accordance with another embodiment of the present invention.

FIG. 8 is a flow diagram illustrating 702 of FIG. 7 in more detail.

FIG. 9 is a block diagram illustrating an apparatus for identifying path information containing a pattern in accordance with an embodiment of the present invention.

FIG. 10 is a block diagram illustrating an apparatus for identifying path information containing a pattern in accordance with another embodiment of the present invention.

FIG. 11 is a block diagram illustrating 1002 of FIG. 10 in more detail.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well-known features may not have been described in detail to avoid unnecessarily obscuring the invention.

Common business questions that need to be answered by analyzing a large network user path data set include:

1. What are the top paths traversed from a particular node to another particular nodes? (e.g., what paths did users commonly follow to go from Yahoo! Finance to Yahoo! Sports).

2. What are the top paths traversed from a particular node to another particular node that encompass certain paths (e.g., what paths did users commonly follow to go from Yahoo! Finance to Yahoo! Sports that included passing through Yahoo! Entertainment first).

3. What are the top paths traversed from a particular node? (e.g., what paths did users commonly follow after Yahoo! Finance).

4. What are the top nodes users left off at without reaching a destination node (starting at some node followed by a sequence of nodes)?

5. What are the top referrers for a given sequence of nodes?

6. What are the nodes that have a maximum affinity to a given node?

The beginning point for various embodiments of the present invention may be a data set of visited paths. This path information may be generated by any number of mechanisms. In an embodiment of the present invention, the paths in the data set may first be evenly split into multiple buckets. A bucket is simply an abstract organizational construct connoting a grouping of information. This allows each of the buckets to be processed in parallel by one or more computers and/or processors. It should be noted that each of the buckets will typically wind up containing all the nodes in the domain set in that paths are not deliberately ordered into specific buckets. However, no limitations are placed on the possibilities for various groupings, including groupings that are made for other purposes beyond the scope of the disclosure, such as grouping certain users, geographic regions, etc. together.

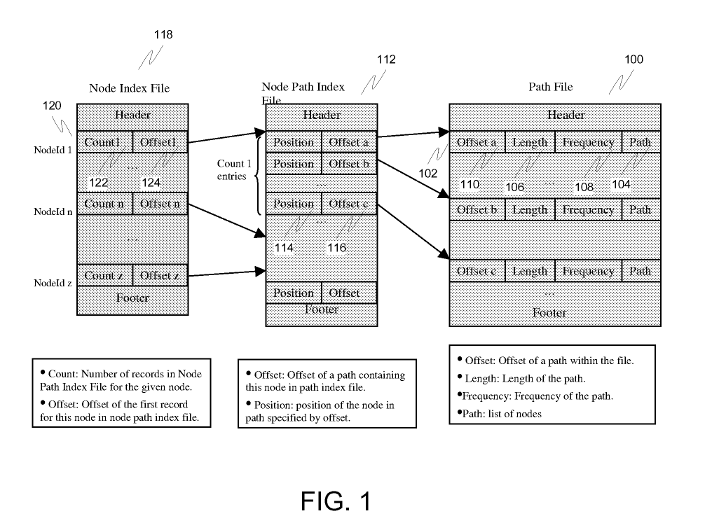

Network path information related to each of the buckets may be organized into three files: a node index file, a node path index file, and a path file. In one embodiment of the present invention these files may be in a binary format. FIG. 1 is a diagram illustrating the structure of the files in accordance with an embodiment of the present invention. Each bucket may contain one of each of these three files. The path file 100 may contain the raw path information from the data set (for the paths placed in this particular bucket). The path file may have one entry 102 for each path. Each entry may include the path itself 104 (expressed, for example, as an ordered list of nodes), information about the length of the path 106, the frequency with which the path occurred 108 (in the data corresponding to the particular bucket), and an offset 110. The offset may represent the location within the file where the entry is present (i.e., the number of entries in the file preceding the current entry). For example, if the entry 102 is the 20th entry in the file, the offset may be 19.

The node path index file 112 may contain an entry for each occurrence of a node in all the paths associated with the bucket. Each entry may carry information about that node in the corresponding path file 100. It may contain the position 114 of the node in the path and an offset 116 into the path file 100 to directly access the information about the path. This offset may also be thought of as a pointer to a particular area of the path file 100 that contains the information about the path.

The node index file 118 may contain one entry for each node that is present in the paths (i.e., a single entry for the node even if the node is present in multiple paths). An entry may also be present for a path even if the path is not present in the corresponding bucket. Each entry 120 may contain a count 122 reflecting the number of entries in the node path index file 112 for the given node. Each entry 120 may also contain an offset 124 pointing to the first entry for the node in the node path index file 112.

Given these three files, data may be accessed very quickly as only the information that is relevant is read by directly navigating to that location in the index files. For example, to obtain all the different paths users have navigated after visiting a Node N, the following method may be performed. First, the node index file 118 may be accessed to determine where the Node N is present. Once this entry is found, the offset 124 may be obtained for this node and the number of entries to be scanned may be obtained by the count 122. Then, using the offset 124, the specific entry in the node path index file 112 may be located. Starting from this entry, a number of entries equal to the retrieved count 122 may be selected. For each of these selected entries, the offsets 116 may be used to identify and extract the corresponding paths in the path file 100.

It should be noted that the use of buckets is optional. Certain implementations are envisioned wherein there are no buckets and the path file 100 contains all of the path information for the entire data set. The same may be said for the node path index file 112 and the node index file 118.

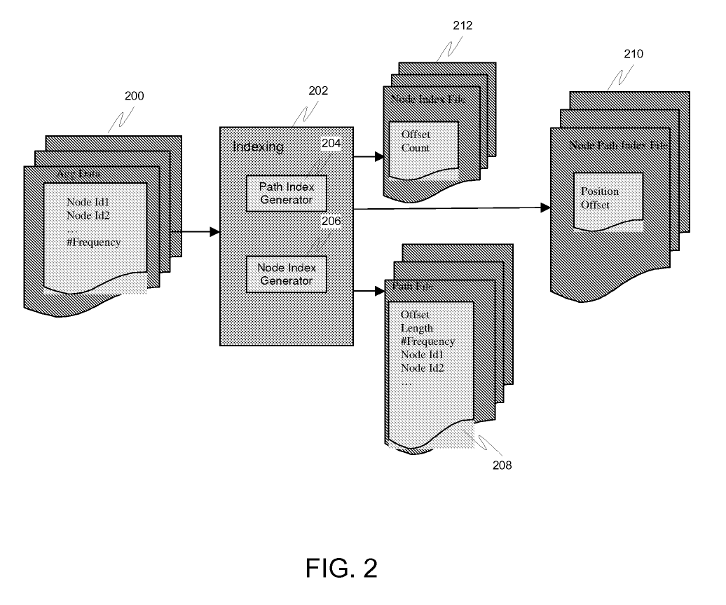

FIG. 2 is a diagram illustrating an architecture of an indexing engine in accordance with an embodiment of the present invention. Aggregated raw path data 200 and the corresponding frequencies may be passed to an indexing engine 202. The indexing engine 202 may include a path index generator 204 and a node index generator 206. The path index generator may be called for each of the individual buckets to generate a path file 208. This may include writing a binary record for each path, the record containing an offset at which it is written, as well as the length of the path and the sequence of nodes that form the path. This may be a variable sized record. Offset and position of node within each path may be tracked separately.

The node index generator 206 may then generate the node path index file 210 and the node index file 212. This process may utilize the node position and the node offset values generated by the path index generator. There may be an entry for each occurrence of a node in the node path index file 210. Each entry may have two components: path offset and the position of the node within the path. The node index file 212 may be an index into the node path index file 210 for each node.

An example is provided for illustrative purposes. This example is not intended to be limiting. Assume that the following distinct paths are in the raw input data set:
1:5:10:2 2
1:5:9:10 1
1:5:10:5 1
1:8:9:10:11:8 10
2:10:11:12 10
2:11:12 5
   where each line indicates one distinct path having two components: the nodes in the path and the payload (frequency). Here, n₁:n₂:n₂ . . . indicates the path. Each nᵢ is the encoded integer value of the node. The number after the path is the frequency (the number of instances where the path occurs in the overall data set).

If there are three output buckets, then each bucket may get two paths. It should be noted that in real-world situations the paths are more likely to be on the order of 500 million with each path containing up to 600 nodes, but for obvious reasons such a complex example will not be described in this document.

The first bucket may contain:
1:5:10:2 2
1:5:9:10 1

The second bucket may contain:
1:5:10:5 1
1:8:9:10:11:8 10

The third bucket may contain:
2:10:11:12 10
2:11:12 5

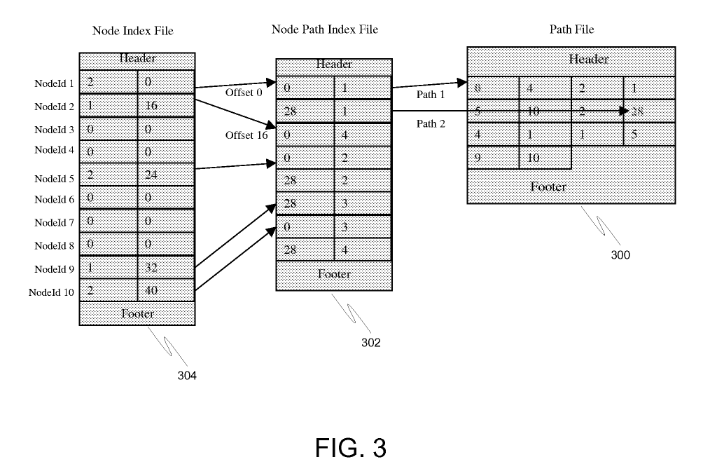

FIG. 3 is a diagram illustrating a path file, node path index file, and node index file for the first bucket in the above example. Here, the path file 300 for the first bucket contains two paths. Path file 300 begins with the sequence 0 4 2, which correspond to the offset, length, and frequency, respectively, corresponding to the first path. Then the path file 300 contains the first path itself (1 5 10 2). Then the path file 300 contains the offset, length and frequency for the second path (28 4 1) followed by the second path (1 5 9 10). Note that the second offset is 28 because the first path record has seven entries. In this example, each entry may be represented using four bytes, thus the second path information begins at the 28th byte. Alternatively, the offset may be based upon the number of the corresponding entry with respect to other entries, regardless of the size of each entry (e.g., the eighth entry may have an offset of seven).

The node path index file 302 may then contain information for each of the nodes in this bucket. The paths in this bucket have only 5 total different nodes. These are 1, 2, 5, 9, and 10. For node 1, the node appears in both paths in the bucket, as such, the node path index file contains two records for node 1. Here, the first record for node 1 contains 0 1, indicating the offset and position, respectively of the node. That is, this first record indicates that node 1 appears in the path beginning at offset 0 in the path file, in the first position in the path. Likewise, the second record (i.e., 28 1) indicates that node 1 appears in the path beginning at offset 28 in the path file, in the first position in the path. Each record in the node path index file 302 may comprise 8 bytes (four bytes each for the offset and the position).

The node index file 304 may contain information on all the nodes present in the whole data set. This may include nodes that are not present in the bucket. In an alternative embodiment, only nodes present in the bucket are represented in the node index file 304. In this example, however, nodes present in the data set but not present in the bucket have entries stored as all zeros. Each record in the node index file 304 has two components, the first one giving the number of entries for the corresponding node in the node path index file for this bucket, and the second one giving the offset at which records corresponding to the node are available in the node path index file for this bucket. Here, the entry for node 1 indicates that there are two entries in the node path index file corresponding to node 1 and these entries begin at offset 0. Likewise, the entry for node 2 indicates that there is only 1 entry in the node path index file corresponding to node 1 and th entry begins at offset 16.

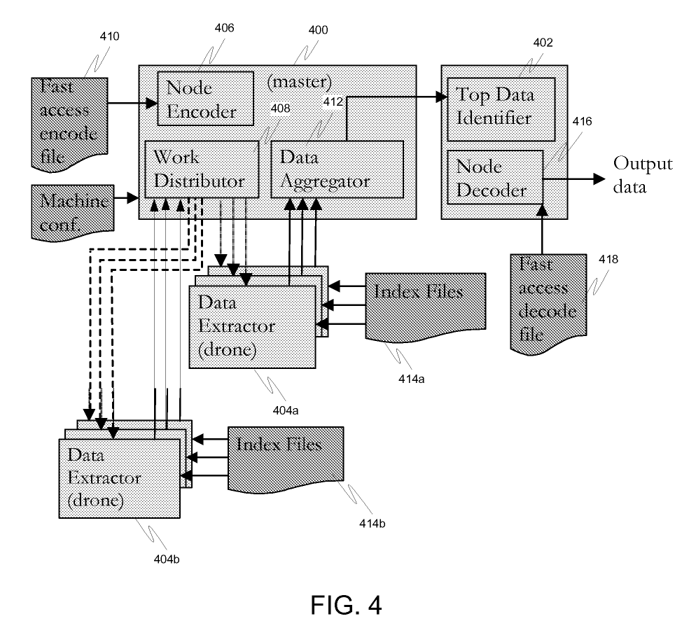

Analysis of the path information in order to answer relevant business questions is simplified by use of various embodiments of the present invention. The efficient identification of patterns in path data may be accomplished by first distributing pattern identification among multiple processes, which allows for parallel processing. Then the patterns may be identified and path information aggregated at the partition level. Then the data from all the partitions may be aggregated, and finally the top data based on the payload may be identified. The payload may contain any other information regarding the path. However, in an embodiment of the present invention, the payload holds frequency information (i.e., information regarding the number of times the path appears in the data set). FIG. 4 is a diagram illustrating an architecture for the efficient identification of patterns in path data in accordance with an embodiment of the present invention. Three main components may perform the above-identified processes. These components may include a master 400, a top data identifier 402, and multiple drones 404a, 404b.

Referring first to the master 400, this module may act generally to distribute the work among the drones 404a, 404b and aggregate the data returned by the drones 404a, 404b. More specifically, the master 400 may first encode pattern information to match the format in which the data is stored using a node encoder 406. If the data is stored as binary index files as described above, then the encoding may include transforming the pattern information to a series of integers corresponding to nodes. Mapping information may be stored in fast access encode files 410 and the node encoder 406 may look up the user pattern (e.g., a sequence of web pages) and convert the pattern definition into an integer representation to match the data stored in the binary index files. The master 400 may then distribute the buckets uniformly among the available drones 404a, 404b using a work distributor 408. As the input data is partitioned into several buckets, each of the drones 404a, 404b gets to process a subset of the buckets.

Once the drones 404a, 404b return sorted data (described in more detail below), the master 400 may aggregate the sorted data using a data aggregator 412. Although each drone 404a, 404b may act on a different data set, since patterns are being identified, it is possible that the same pattern may be returned by different drones. As such, the master 400 may aggregate the payload from all the drones to identify such duplications and handle them accordingly (e.g., aggregate two or more identical patterns to a single pattern having a frequency count). Finally, the master 400 may send the aggregated data to the top data identifier 402.

Referring to the drones 404a, 404b, these modules may generally extract requested patterns. These patterns may be specified by users, or may be generated by the drones or other processes, in order to aid in answering questions relevant to users. These patterns may be extracted from specified buckets, and the drones may then aggregate the common data and send the results to the master 400. As such, the drones 404a, 404b may have access to the binary index files 414a, 414b whereas the master 400 and top data identifier 402 may not.

Specifically, each drone may first identify all the paths that satisfy a given pattern (which may include a specified source, destination, and via nodes, if any). The identification process may work backwards, since the destination node is typically the convergence node and hence will have fewer number of paths to be considered. Since there may be multiple nodes specified in each of the patterns, the identification process may collect paths, taking into consideration all the nodes in any step. If a constraint is specified to extract paths with certain patterns, each drone may then perform pattern matching among the identified paths. For example, given a pattern where a sequence of nodes are expected to be adjacent to each other or separated by a constant number of nodes in between, the drones may examine identified paths satisfying the pattern and remove paths that do not meet the constraint. Once the paths that have valid patterns have been identified, the desired information may be extracted by those paths and stored in memory. It should be noted that the aforementioned steps performed by each drone may then be repeated for each bucket assigned to the drone. once this is completed, all the extracted information from each of the buckets may be aggregated so that the payload for the same identified pattern is added together. This aggregated data may then be sorted and sent to the master 400 by each drone 404a, 404b.

Referring to the top data identifier 402, this module may generally be instructed to fetch the top N results (patterns and associated payload) out of all the identified results. This module may also produce summary data (e.g., the total number of patterns identified for the specified pattern and their total payload) in addition to the top N results. This module may get the aggregated data from the master.

Specifically, the top data identifier 402 may first parse the input data and extract the pattern and its associated payload. Then it may store the data associated with the top payload, eliminating the insignificant data by keeping only the summary (total distinct data sets and their total payload). Then a summary followed by the top data and their payload may be outputted. Here, the top data (patterns) may be decoded (from, e.g., integer representation to web page identification) with a node decoder 416 using the stored mapping information from the data access decode files 418.

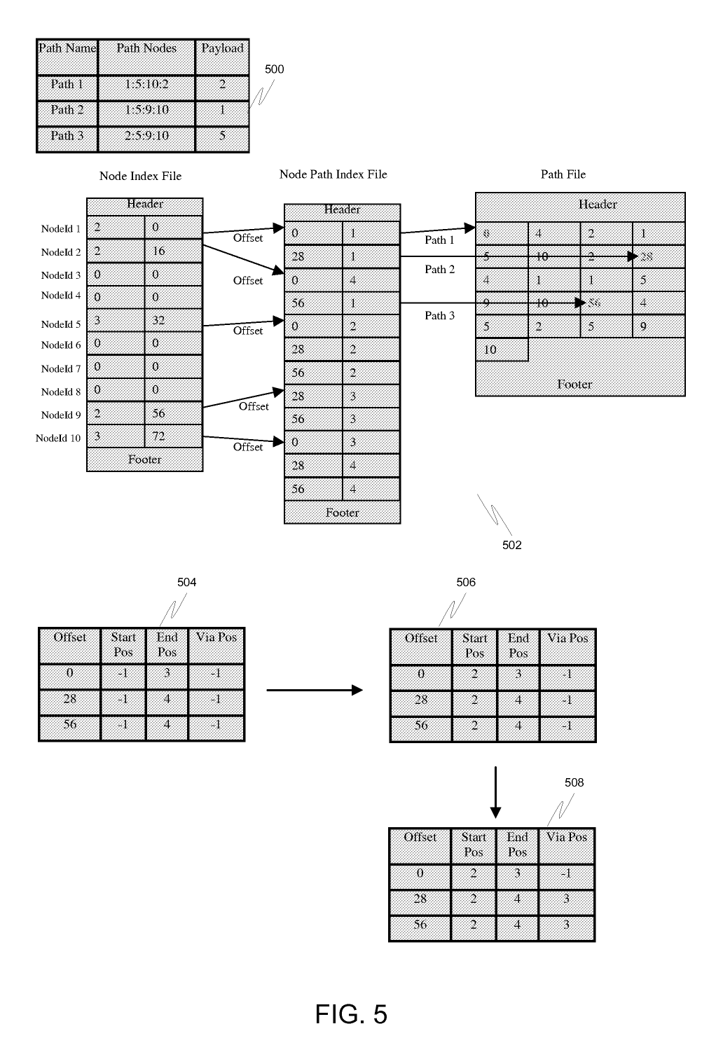

FIG. 5 is a diagram illustrating an example of how patterns are extracted using a drone in accordance with an embodiment of the present invention. For simplicity, only one bucket of data with three paths is considered in this example. The paths are labeled as 500 in FIG. 5. Given these three paths, the binary index files for these paths are labeled as 502 in FIG. 5. Assume that the drone is given the task of extracting the patterns that begin with node 5, go through node 9, and end with node 10.

The drone may first identify the paths with node 10 and store the corresponding end positions in the paths. This may be achieved by locating the information for node 10 in the node index file. From this it can be seen that node 10 occurs 3 times and the information about the position of the node in the corresponding paths is at offset 72 in the node path index file. From the node path index file, it can be seen that a path containing node 10 at position 3 (in path 1, which starts at position 0 in the path file), a second path with node 10 at position 4 (in path 2, which starts at position 28 in the path file), and a third path with node 10 at position 4 (in path 2, which starts at position 56 in the path file). A data structure may be set up as labeled as 504 in FIG. 5, with starting and intermediate (via) positions initialized to invalid (e.g., −1).

For the paths identified in the first step, the drone may then obtain the start positions for node 5. To facilitate this, node 5 may be located in the node index file. Node 5 occurs 3 times. Since all of the relevant paths were identified in the previous step, the start positions for the paths in the data structure 504 may be updated. If there were paths having node 5 for which there are no entries in the data structure 504, then those paths would have been ignored. Additionally, if the position of a start node in a path is more than the end position (i.e., node 5 appears after node 10 in the path), then such paths will also be ignored. The data structure 504 is then updated with the start position information to produce data structure 506.

For the paths identified in the previous steps, the drone may then filter out those that contain node 9 in an intermediate position. Once again the node index file may be accessed to determine that node 9 is present in two paths at position 3. Since this position falls in the range between the start position and the end position, the path is considered valid and the data structure 506 is updated to include the intermediate position information to produce data structure 508. Since one of the 3 paths in data structure 506 wound up not containing node 9 in an intermediate position, the data structure 508 still reflects an invalid entry for the intermediate position of this path. It should also be noted that if multiple intermediate nodes are specified as part of the pattern, then this intermediate node inspection step is repeated for each of the specified intermediate nodes.

Given data structure 508, the drone may then proceed to extract the corresponding path data. Since the path beginning at offset 0 contains an invalid entry in the intermediate position, this path will be ignored. The pattern identified as beginning at position 2 and ending at position 4 at offset 28 may then be retrieved, resulting in the pattern “5:9:10”. Likewise, the pattern identified as beginning at position 2 and ending at position 4 at offset 56 may be retrieved, which also results in the pattern 5:9:10. Since the same pattern was obtained from two different paths with different payloads, the drone may then aggregate the payload and stream the pattern back with the aggregated payload. Here, the second path had a payload of 1 and the third path had a payload of 5. Thus, the drone may aggregate this information into a single pattern of 5:9:10 with a payload of 6. if there is a need to perform pattern matching after extraction of data from the path index files (e.g., adjacency checks), the pattern matching may be performed at this time. The drone then sends the extracted patterns to the master, which then performs the aggregation of the payload fields for identical patterns from all the drones. For example, if another drone returned the same pattern (5:9:10) with a payload of 2, the master may aggregate all these identical patterns to result in a payload of 8.

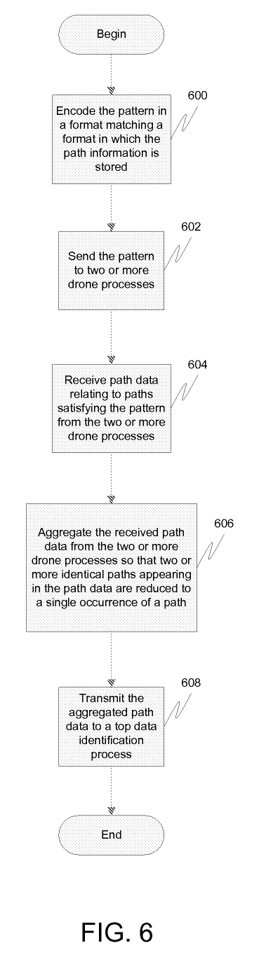

FIG. 6 is a flow diagram illustrating a method for identifying path information containing a pattern in accordance with an embodiment of the present invention. The path information may relate to network nodes visited by users of a computer network. The method may be executed at a master process. At 600, the pattern may be encoded in a format matching a format in which the path information is stored. Mapping information relating to the encoding may be stored in a mapping file. At 602, the pattern may be sent to two or more drone processes. The two or more drone processes may be executed by different processors. At 604, path data relating to paths satisfying the pattern may be received from the two or more drone processes along with payload information corresponding to the paths. At 606, the path data received from the two or more drone processes may be aggregated so that two or more identical paths appearing in the path data are reduced to a single occurrence of a path. At 608, the aggregated path data may be transmitted to a top data identification process. The top data identification process may produce summary data and a top number of results from the aggregated path data.

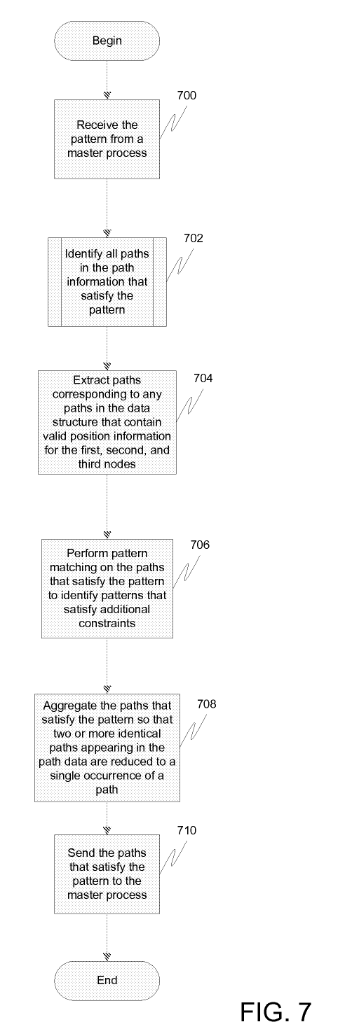

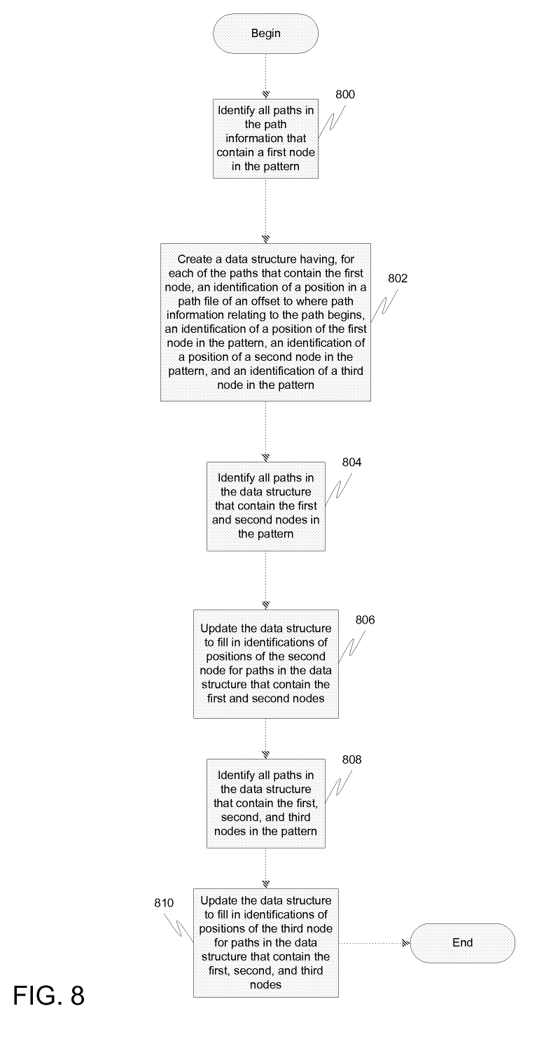

FIG. 7 is a flow diagram illustrating a method for identifying path information containing a pattern in accordance with another embodiment of the present invention. The path information may relate to network nodes visited by users of a computer network. The method may be executed at a drone process. At 700, the pattern may be received from a master process. At 702, all paths in the path information that satisfy the pattern may be identified. FIG. 8 is a flow diagram illustrating 702 of FIG. 7 in more detail. At 800, all paths in the path information that contain a first node in the pattern may be identified. At 802, a data structure may be created having, for each of the paths that contain the first node, an identification of a position in a path file of an offset to where path information relating to the path begins, an identification of a position of the first node in the pattern, an identification of a position of a second node in the pattern, and an identification of a third node in the pattern. It should be noted that this embodiment assumes a three node pattern. However, embodiments are possible with any number of different nodes. Identifications of the positions of any nodes beyond the first node may be initialized to invalid (e.g., −1). At 804, all paths in the data structure that contain the first and second nodes in the pattern may be identified. At 806, the data structure may be updated to fill in identifications of positions of the second node for paths in the data structure that contain the first and second nodes. At 808, all paths in the data structure that contain the first, second, and third nodes in the pattern may be identified. At 810, the data structure may be updated to fill in identifications of positions of the third node for paths in the data structure that contain the first, second, and third nodes.

Referring back to FIG. 7, at 704, paths corresponding to any paths in the data structure that contain valid position information for the first, second, and third nodes may be extracted from the path file. This may include only paths that have a position for the second node less than a position for the third node, and a position for the first node less than a position for the second node. At 706, pattern matching may be performed on the paths that satisfy the pattern to identify patterns that satisfy additional constraints. At 708, the paths that satisfy the pattern may be aggregated so that two or more identical paths appearing in the path data are reduced to a single occurrence of a path. At 710, the paths that satisfy the pattern may be sent to the master process.

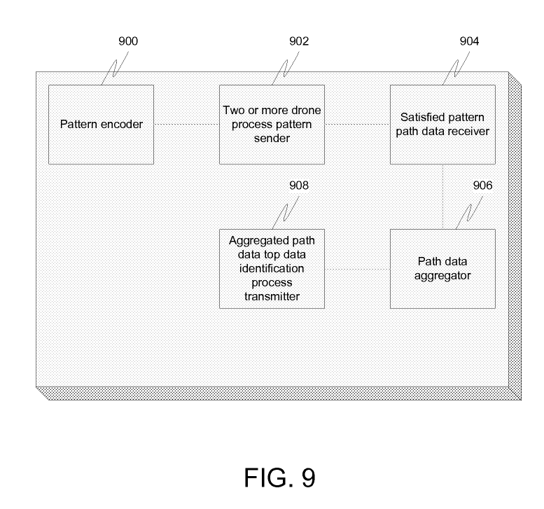

FIG. 9 is a block diagram illustrating an apparatus for identifying path information containing a pattern in accordance with an embodiment of the present invention. The path information may relate to network nodes visited by users of a computer network. The apparatus may be a master process, such as 400 of FIG. 4. A pattern encoder 900 may encode the pattern in a format matching a format in which the path information is stored. Mapping information relating to the encoding may be stored in a mapping file. A two or more drone process pattern sender 902 coupled to the pattern encoder 900 may send the pattern to two or more drone processes. The two or more drone processes may be executed by different processors. A satisfied pattern path data receiver 904 may receive path data relating to paths satisfying the pattern from the two or more drone processes along with payload information corresponding to the paths. A path data aggregator 906 coupled to the satisfied pattern path data receiver 904 may aggregate the path data received from the two or more drone processes so that two or more identical paths appearing in the path data are reduced to a single occurrence of a path. An aggregated path data top data identification process transmitter 908 coupled to the path data aggregator 906 may transmit the aggregated path data to a top data identification process. The top data identification process may produce summary data and a top number of results from the aggregated path data.

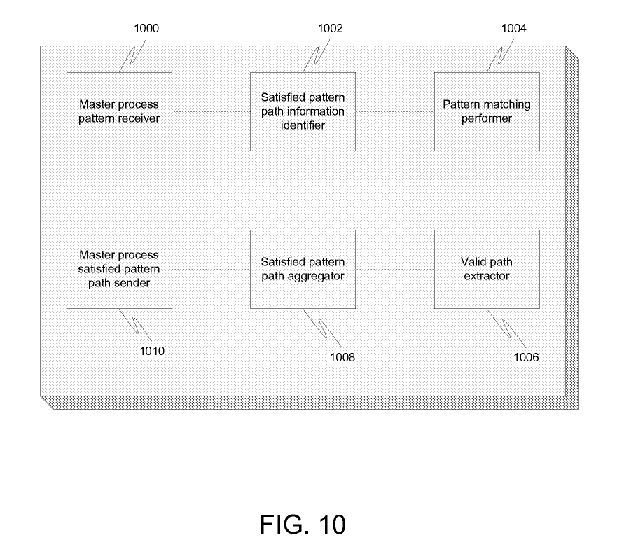

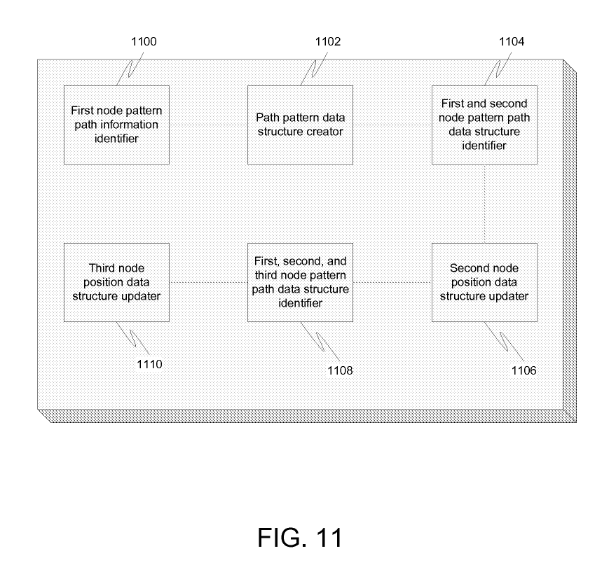

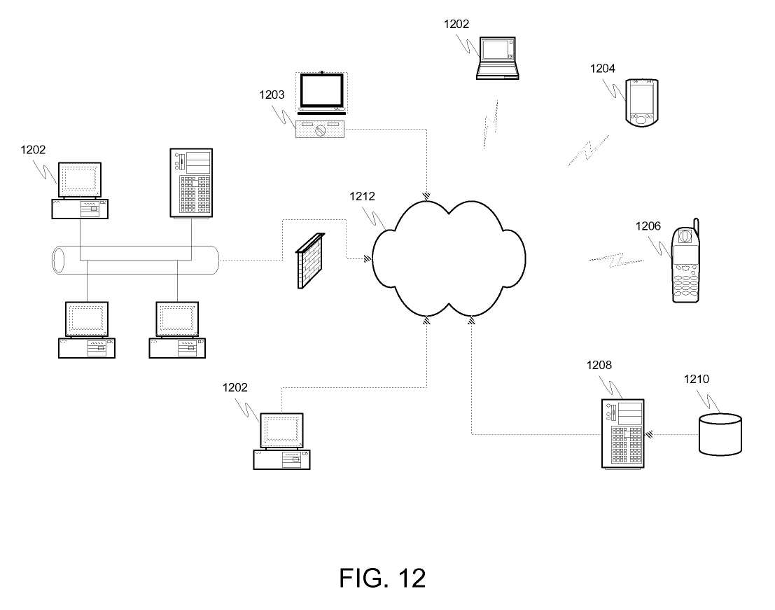

FIG. 10 is a flow diagram illustrating an apparatus for identifying path information containing a pattern in accordance with another embodiment of the present invention. The path information may relate to network nodes visited by users of a computer network. The apparatus may be a drone process, such as 404a or 404b of FIG. 4. A master process pattern receiver 1000 may receive the pattern from a master process. A satisfied pattern path information identifier 1002 coupled to the master process pattern receiver 1002 may identify all paths in the path information that satisfy the pattern. FIG. 11 is a block diagram illustrating 1002 of FIG. 10 in more detail. A first node pattern path information identifier 1100 may identify all paths in the path information that contain a first node in the pattern. A path pattern data structure creator 1102 coupled to the first node pattern path information identifier 1100 may create a data structure having, for each of the paths that contain the first node, an identification of a position in a path file of an offset to where path information relating to the path begins, an identification of a position of the first node in the pattern, an identification of a position of a second node in the pattern, and an identification of a third node in the pattern. It should be noted that this embodiment assumes a three node pattern. However, embodiments are possible with any number of different nodes. Identifications of the positions of any nodes beyond the first node may be initialized to invalid (e.g., −1). A first and second node pattern path data structure identifier 1104 coupled to the path pattern data structure creator 1102 may identify all paths in the data structure that contain the first and second nodes in the pattern. A second node position data structure updater 1106 coupled to the first and second node pattern path data structure identifier 1104 may update the data structure may be updated to fill in identifications of positions of the second node for paths in the data structure that contain the first and second nodes. A first, second, and third node pattern path data structure identifier 1108 coupled to the second node position data structure updater 1106 may identify all paths in the data structure that contain the first, second, and third nodes in the pattern. A third node position data structure updater 1110 coupled to the first, second, and third node pattern path data structure identifier 1108 may update the data structure to fill in identifications of positions of the third node for paths in the data structure that contain the first, second, and third nodes.

Referring back to FIG. 10, a pattern matching performer 1004 coupled to the satisfied pattern path information identifier 1102 may perform pattern matching on the paths that satisfy the pattern to identify patterns that satisfy additional constraints. A valid path extractor 1006 coupled to the pattern matching performer 1004 may extract paths corresponding to any paths in the data structure that contain valid position information for the first, second, and third nodes from the path file. This may include only paths that have a position for the second node less than a position for the third node, and a position for the first node less than a position for the second node. A satisfied pattern path aggregator 1008 coupled to the valid path extractor 1006 may aggregate the paths that satisfy the pattern so that two or more identical paths appearing in the path data are reduced to a single occurrence of a path. A master process satisfied pattern path sender 1110 coupled to the satisfied pattern path aggregator 1008 may send the paths that satisfy the pattern to the master process.

It should also be noted that the present invention may be implemented on any computing platform and in any network topology in which search categorization is a useful functionality. For example and as illustrated in FIG. 12, implementations are contemplated in which the node path files described herein is employed in a network containing personal computers 1202, media computing platforms 1203 (e.g., cable and satellite set top boxes with navigation and recording capabilities (e.g., Tivo)), handheld computing devices (e.g., PDAs) 1204, cell phones 1206, or any other type of portable communication platform. Users of these devices may navigate the network, and path information may be collected by server 1208. Server 1208 may then utilize the various techniques described above to store and access path information in an efficient manner. Applications may be resident on such devices, e.g., as part of a browser or other application, or be served up from a remote site, e.g., in a Web page, (represented by server 1208 and data store 1210). The invention may also be practiced in a wide variety of network environments (represented by network 1212), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for identifying path information containing a pattern, wherein the path information relates to network nodes visited by users of a computer network, the method comprising:
sending the pattern of path information to two or more drone processes;
receiving, from the two or more drone processes, path data containing paths satisfying the pattern along with payload information corresponding to the paths;
aggregating the path data received from the two or more drone processes so that two or more identical paths appearing in the path data are reduced to a single occurrence of a path; and
transmitting the aggregated path data to a top data identification process.

2. The method of claim 1, wherein the two or more drone processes are executed by different processors.

3. The method of claim 1, further comprising:
encoding the pattern in a format matching a format in which the path information is stored.

4. The method of claim 3, wherein mapping information relating to the encoding is stored in a mapping file separate from the path data.

5. The method of claim 1, wherein the top data identification process produces summary data containing a summary of the path data and a top number of results from the aggregated path data.

6. A method for identifying path information containing a pattern, wherein the path information relates to network nodes visited by users of a computer network, the method executed at a drone process and comprising:
receiving the pattern from a master process;
identifying all paths in the path information that satisfy the pattern; and
sending the paths that satisfy the pattern to the master process.

7. The method of claim 6, further comprising:
aggregating the paths that satisfy the pattern so that two or more identical paths appearing in the path data are reduced to a single occurrence of a path.

8. The method of claim 6, further comprising:
performing pattern matching on the paths that satisfy the pattern to identify patterns that satisfy additional constraints.

9. The method of claim 6, wherein the identifying includes:
identifying all paths in the path information that contain a first node in the pattern;
creating a data structure having, for each of the paths that contain the first node, an identification of a position in a path file of an offset to where path information relating to the path begins, an identification of a position of the first node in the pattern, and an identification of a position of the second node in the pattern, wherein the identifications of the positions of the second node are initialized to invalid;
identifying all paths in the data structure that contain the first and second nodes in the pattern; and
updating the data structure to fill in identifications of positions of the second node for paths in the data structure that contain the first and second nodes.

10. The method of claim 9, further comprising:
extracting paths from the path file corresponding to any paths in the data structure that contain valid position information for both the first and second nodes.

11. The method of claim 9, further comprising:
extracting paths from the path file corresponding to any paths in the data structure that contain valid position information for both the first and second nodes and that also contain a position for the first node that is less than a position for the second node.

12. The method of claim 9, wherein the data structure further includes an identification of a position of a third node in the pattern and wherein the method further comprises:
identifying all paths in the data structure that contain the first, second, and third nodes in the pattern; and
updating the data structure to fill in identifications of positions of the third node for paths in the data structure that contain the first, second, and third nodes.

13. A system for identifying path information containing a pattern, wherein the path information relates to network nodes visited by users of a computer network, the system comprising:
a master process;
two or more drone processes; and
a top path identification process;
wherein the master process is configured to send pattern information to the two or more drone processes, receive aggregated path data from the two or more drone processes, aggregate the aggregated path data from the two or more drone processes, and transmit the results of the aggregation to the top path identification process;
wherein the two or more drone processes are each configured to identify paths in different sets of path information that contain the pattern, aggregate the identified paths, and return the aggregated path data to the master process; and
wherein the top path identification process is configured to summarize and output a top number of results from the results transmitted from the master process.

14. An apparatus for identifying path information containing a pattern, wherein the path information relates to network nodes visited by users of a computer network, the apparatus comprising:
a two or more drone process pattern sender;
a satisfied pattern path data receiver;
a path data aggregator coupled to the satisfied pattern path data receiver; and
an aggregated path data top data identification process transmitter coupled to the path data aggregator.

15. A drone apparatus for identifying path information containing a pattern, wherein the path information relates to network nodes visited by users of a computer network, the drone apparatus comprising:
a master process pattern receiver;
a satisfied pattern path information identifier coupled to the master process pattern receiver; and
a master process satisfied pattern path data sender coupled to the satisfied pattern path information identifier.

16. An apparatus for identifying path information containing a pattern, wherein the path information relates to network nodes visited by users of a computer network, the apparatus comprising:
means for sending the pattern of path information to two or more drone processes;
means for receiving, from the two or more drone processes, path data containing paths satisfying the pattern along with payload information corresponding to the paths;
means for aggregating the path data received from the two or more drone processes so that two or more identical paths appearing in the path data are reduced to a single occurrence of a path; and
transmitting the aggregated path data to a top data identification process.

17. An drone apparatus for identifying path information containing a pattern, wherein the path information relates to network nodes visited by users of a computer network, the drone apparatus comprising:
means for receiving the pattern from a master process;
means for identifying all paths in the path information that satisfy the pattern; and
means for sending the paths that satisfy the pattern to the master process.

18. A program storage device readable by a machine, tangibly embodying a program of instructions executable by the machine to perform a method for identifying path information containing a pattern, wherein the path information relates to network nodes visited by users of a computer network, the method comprising:
sending the pattern of path information to two or more drone processes;
receiving, from the two or more drone processes, path data containing paths satisfying the pattern along with payload information corresponding to the paths;
aggregating the path data received from the two or more drone processes so that two or more identical paths appearing in the path data are reduced to a single occurrence of a path; and
transmitting the aggregated path data to a top data identification process.

19. A program storage device readable by a machine, tangibly embodying a program of instructions executable by the machine to perform a method for identifying path information containing a pattern, wherein the path information relates to network nodes visited by users of a computer network, the method executed at a drone process and comprising:
receiving the pattern from a master process;
identifying all paths in the path information that satisfy the pattern; and
sending the paths that satisfy the pattern to the master process.
